(19) United States
(12) Patent Application Publication
(10) Pub. No.: US 2011/0132888 A1
(43) Pub. Date: Jun. 9, 2011

(54) DEVICE FOR ELECTRICALLY CONNECTING LAMINATED GLAZING TO AN APPARATUS OUTSIDE THE GLAZING, METHOD FOR ASSEMBLING GLAZING PROVIDED WITH ONE SUCH CONNECTION DEVICE, AND RESULTING GLAZING

(75) Inventor: Annabelle Andreau-Wiedermaier, Aachen (DE)

(73) Assignee: SAINT-GOBAIN GLASS FRANCE, Courbevoie (FR)

(21) Appl. No.: 12/992,739

(22) PCT Filed: May 15, 2009
(86) PCT No.: PCT/FR2009/050914

§ 371 Date: Feb. 15, 2011

(30) Foreign Application Priority Data
May 16, 2008 (FR) 0853166

(51) Int. Cl. H05B 3/84; H01R 13/60; H01R 43/02

(52) U.S. Cl. 219/203; 439/527; 29/843

(57) ABSTRACT

A connection device configured to equip a laminated glazing unit requiring an electrical connection to equipment outside of the glazing unit. The laminated glazing unit includes at least one set of two sheets having a glass function between which are positioned a lamination interlayer sheet and at least one current lead. The connection device includes conductive portions that extend both on the inside and outside of the glazing unit, the internal conductive region configured to be connected to the current lead(s) and the external conductive region configured for connection to the equipment outside of the glazing unit and protected by an insulating shell. The external conductive region with its insulating shell is in a form of a connection box for connection via wiring to the equipment outside the glazing unit, the box including a mechanism receiving the conductive portion inside the glazing unit.

The present invention relates to an electrical connection device intended to connect a laminated glazing unit to equipment outside the glazing unit. It also relates to a process for manufacturing a glazing unit provided with such a connection device and also to the glazing unit thus equipped.

As examples of glazing units to which the present invention relates, mention may be made of heated glazing units, glazing units having electrically controlled optical properties, and glazing units that have a function.
Heated glazing units, such as the windshields and rear windows of motor vehicles, are constituted by a stack that comprises at least two sheets of glass, positioned between which is a thermoplastic interlayer sheet, for example made of polyurethane, applied to one face of which is a network of thin electric heating resistance wires, each thin wire being electrically connected, at each of its ends, to a current lead. These current leads are, for example, constituted of copper foil strips covered with a low-melting-point tin-based alloy.

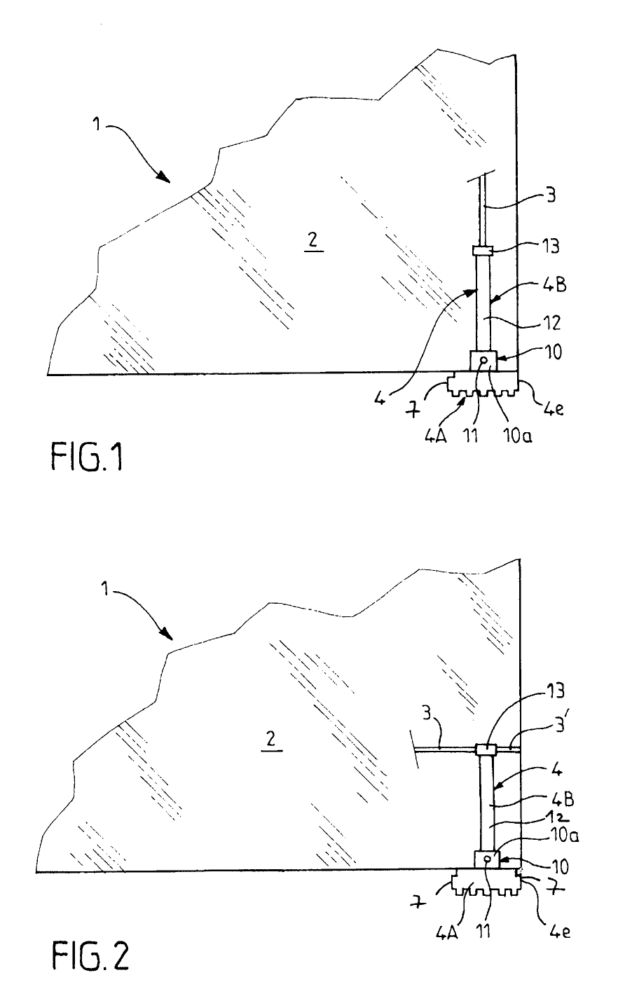

A connection device according to the invention may be used to connect one of the current leads to a terminal of an electrical power source, the other current lead being connected to the other terminal.
Glazing units having electrically controlled optical properties, one example of which will be described in more detail below with reference to FIG. 1, are glazing units capable of changing instantaneously from a transparent state to a translucent state in which they hide from view a habitable room, an office, a counter, etc.

These are generally laminated glazing units which are composed of two sheets having a glass function, especially made of glass or made of plastic, applied to each of which is a thin transparent layer of the conductive material such as indium tin oxide (ITO) that constitutes an electrode.

The two sheets having a glass function are positioned with the transparent layers that form electrodes facing one another, an interlayer film being placed between the two transparent electrodes. This film is especially the film of a transparent polymer matrix that traps liquid crystal droplets.

The operating principle of such glazing units, consists in adapting the refractive index of the polymer matrix and the ordinary index of the liquid crystal droplets when the latter are aligned under the effect of an electric field, which gives the glazing unit a transparent state. In the absence of an electric field, the liquid crystal molecules in each droplet are oriented in one and the same direction, but their orientation direction varies from one droplet to the next. There is then scattering of the incident light, giving the glazing unit a translucent appearance.

Positioned on each of the electrodes is a busbar or a conductive strip that forms a current lead, deposited for example by screen printing on the electrode layer, or welded thereto, along one edge of the sheet of glass in question.

A connection device according to the invention may be used to connect one of the busbars to a current input, another connection device of the same type being used to connect the other busbar to the current output.
Glazing units that have a function are, for example, motor vehicle glazing units having an incorporated radio antenna and glazing units that incorporate at least one sensor.

Glazing units having an incorporated radio antenna are generally constituted by laminated glazing comprising an intermediate sheet in which an antenna wire is positioned. The connection device according to the invention is used, for example, to connect this antenna wire to a motor vehicle radio.

The glazing units mentioned above are all laminated glazing units which comprise at least two sheets having a glass function, in particular made of glass or made of a plastic such as polymethyl methacrylate, polycarbonate or polyethylene terephthalate, located between which is an interlayer sheet (lamination interlayer), generally made of a plastic such as a polymer material, for instance polyurethane. These glazing units may be classified as two families:
a first family simply comprises the two sheets having a glass function, between which the lamination interlayer is located;
a second family of glazing units comprises, as before, the two sheets having a glass function and the lamination interlayer, but with interposition of a thin layer that forms an electrode between each sheet of glass and the lamination interlayer, these electrodes serving as an electrical power source for an active system associated with the lamination interlayer.

Regardless of the type of glazing unit, the electrical power supply is generally provided by at least one current lead within the glazing unit that is electrically connected both to the components inside the glazing unit that require this supply and to an external electrical power source. One current lead is therefore in contact with the associated electrode layer in the case of the second family of aforementioned glazing units.

The connection of the current lead to the electrical power source is provided by an element, known as a connection element, comprising, generally, conductive portions that lie within the glazing unit and on the outside thereof, and heating of the conductive portions external to the glazing unit.

The external conductive portions provide the actual connection. They may be two welded metal prongs or two lugs or else ferrules or any other connection means. In order to protect these external conductive portions with respect to the outside environment, especially impacts and moisture, a coating customarily envelopes these conductive portions.

The coating may be constituted, for example, by an insulating strip wound or extruded around the conductive portions external to the glazing unit. It may also be a heatshrunk strip. However, the solidity and the sealing of the connection element do not always correspond to the desired requirements. Furthermore, the extruded coating often has protrusions which may be visible.

The coating may also be constituted of a part comprising recesses in order to insert therein the external conductive portions. This part is adhesively bonded to the glazing unit. The adhesive makes it possible both to ensure the sealing of the connection element and contributes to the solidity of the assembly.

This solution, although satisfactory, has however, a relatively large space requirement at the edge of the glazing unit, in particular due to the flow of the adhesive. Furthermore, it is not always possible to predict the extent of this flow and therefore to control the space requirement of the connection element on the glazing unit.

In order to reduce this space requirement and simultaneously improve the reliability, the solidity and the sealing of the assembly, it has been proposed, in accordance with European Patent Application EP 0 619 691, that the coating of the external conductive portions be molded directly on the glazing unit.

However, the solution thus proposed remains rather unsatisfactory. Indeed, the operations for coating by direct molding on the glazing unit are numerous and are not easy. One mold must be manufactured per type of connection device. Furthermore, if it is desired to obtain good sealing of the connection, a cable must be connected to the connection device, and must be integrated into the coating during the molding thereof on the glazing unit. Another drawback is then that this cable hangs from the glazing unit, and that it could tear off the connection device if the cable is involuntarily pulled, for example during the transport of the glazing unit. The anchorage of this type of connection device in the glazing unit must be solid, the glazing unit no longer being able to be used if the device is torn off, which constitutes a significant loss, since the price of these laminated glazing units, especially those having glazing with active systems, is generally high.

Equally, the coating is often bulky and generally covers a portion of the two corresponding outside edges of the sheets having a glass function, which may be a drawback during the installation of the glazing unit.

The present invention aims to overcome these drawbacks by proposing a connection device that is simple to install, which may not be very bulky, and which may advantageously have both means that favor good anchoring to the glazing unit and means for sealing the connection of the glazing unit to the systems outside the glazing unit.

One subject of the present invention is therefore firstly a connection device intended to equip a laminated glazing unit requiring an electrical connection to equipment outside of the glazing unit, said laminated glazing unit comprising at least one set of two sheets having a glass function between which are positioned a lamination interlayer sheet and at least one current lead, said connection device comprising conductive portions that extend both on the inside and on the outside of the glazing unit, the internal conductive region being intended to be connected to the aforementioned current lead(s) and the external conductive region being adapted for the connection to the equipment outside of the glazing unit and being protected by an insulating shell, characterized by the fact that the external conductive region with its insulating shell is produced in the form of a connection box for connection via wiring to the equipment outside the glazing unit, said box having a means of receiving the conductive portion inside the glazing unit.

The box is advantageously arranged in order to be applied against the glazing unit, in particular against the edge of the glazing unit.

The conductive portion intended to extend on the inside of the glazing unit may be formed by a tab or braid of conductive material, which, in the assembled position of the connection device, enters into a slot of the box in order to be connected to the external conductive portion that is inside the latter. In accordance with one particular embodiment, the external connection box comprises, in its junction zone with the tab of conductive material, a part that forms a case as a single piece with it (for molding with the box), in which said tab extends.

The box may externally comprise one or two connectors that each bear a male lug or a female lug for the purpose of a connection to a respectively female or male plug of a connection cable that connects to the power source. The or each connector may have means that cooperate, in particular by snap fastening, with complementary means of the plug of the connection cable, in order to seal the connector-plug connection.

In accordance with one advantageous feature of the connection device according to the present invention, the box and/or the internal conductive portion and/or, when it is present, the part that forms a junction case between the box and the tab-shaped internal conductive portion, comprise anchoring means intended to cooperate with the glazing unit in order to strengthen the fastening of said connection device.

These anchoring means may consist of holes, pins, projections or ribs for anchoring the flexible material of the interlayer sheet, the means of anchoring the box being intended to cooperate with an overlap of the interlayer sheet in the region of application of the box against the glazing unit, in particular against the edge thereof.

Should the case part have been provided, the case may have lateral extensions that favor the anchoring in the material of the interlayer sheet.

Another subject of the present invention is a process for assembling a laminated glazing unit equipped with at least one connection device as defined above, characterized by the fact that the connection device is placed on a sheet of the glazing unit comprising at least one current lead, that the internal conductive portion of the connection device is welded to one end of the current lead(s), the box butting against the glazing unit, that the stack of sheets making up the laminated glazing unit is supplemented, the intermediate interlayer sheet being, where appropriate, chosen to have a dimension that enables it to jut out from the glazing unit in the region of the box so that the flow of the material of the interlayer sheet in this region during the assembling of the stack of sheets strengthens the anchoring of the box, such an anchoring possibly being favored by holes, pins, projections or ribs borne by the latter.

Another subject of the present invention is a laminated glazing unit requiring an electrical connection to equipment outside of the glazing unit, said laminated glazing unit comprising at least one set of two sheets having a glass function between which are positioned a lamination interlayer sheet and at least one current lead, said glazing unit being equipped with at least one connection device as defined above or that has been assembled by a process as defined above.

According to the applications provided, the glazing unit may comprise a lamination interlayer sheet directly in contact with the adjacent sheets having a glass function, the current lead(s) being positioned on the interlayer sheet, or the glazing unit may comprise a lamination interlayer sheet in contact with the adjacent sheets having a glass function with interposition of a thin layer forming an electrode deposited on the sheet having a glass function, the current lead(s) being positioned on the thin layer that forms an electrode.

One example of the first type of glazing unit is a heated glazing unit, the interlayer sheet comprising heating resistance wires connected to one or some current lead(s).

One example of the second type of glazing unit is a glazing unit having electrically controlled optical properties, the thin layers that form electrodes serving as an electrical power source for an active system constituted by liquid crystals which one within the matrix of the lamination interlayer sheet and which make it possible to modify the opacity of the glazing unit as a function of the voltage applied to the electrodes.

To better illustrate the connection device according to the present invention, several embodiments thereof will be described below, by way of indication and non-limitingly, with reference to the appended drawings.

In these drawings:

FIG. 1 is a partial top plan view of a sheet of glass of a transparent laminated glazing unit, showing a connection device according to the invention that has one connector, in accordance with a first variant;

FIG. 2 is a view similar to FIG. 1, with a connection device according to the invention that has two connectors, in accordance with a second variant;

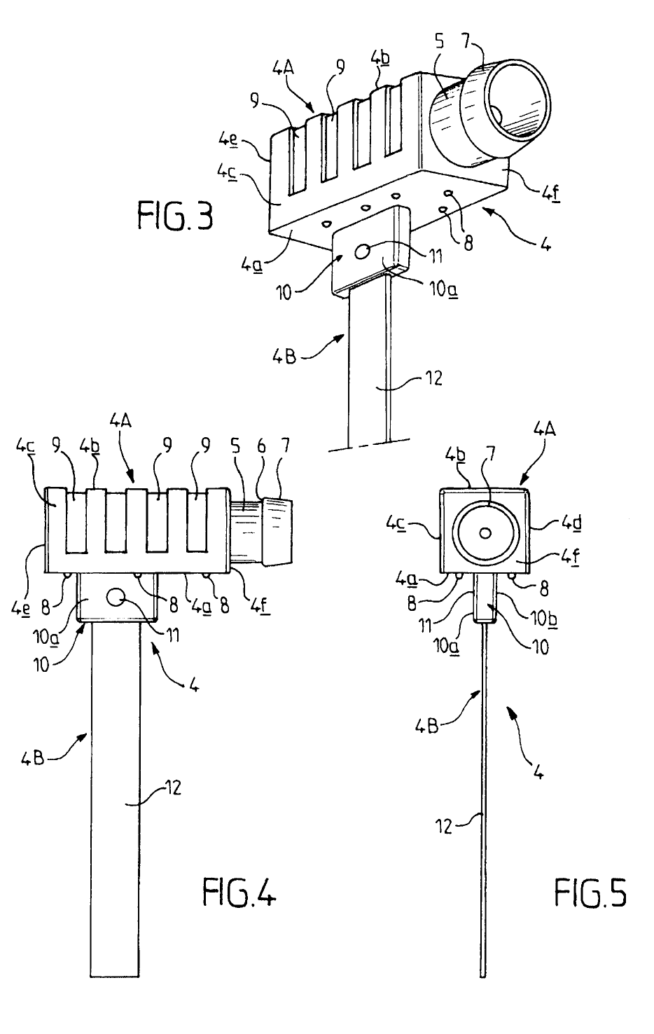

FIG. 3 is a perspective view of the connection device from FIG. 1, the tab thereof being partially represented; and

FIGS. 4 and 5 are respectively a side elevation view and a side end view of the connection device from FIG. 1.

With reference to FIG. 1, it can be seen that a laminated glazing unit 1 having electrically controlled optical properties has been represented, such as that sold by Saint-Gobain Glass under the trade mark SGG PRIVALITE.

This glazing unit is composed of two sheets 2 made of glass or made of a plastic, such as PMMA, PC or PET, applied to each of which is a thin transparent layer of a conductive material such as ITO that constitutes an electrode. The electric current is brought to a layer that forms an electrode via a busbar or a conductive strip (strip of copper 3 represented partially in FIG. 1), more generally forming a current lead, connected to said layer forming an electrode along one edge of the sheet 2 in question. In this example, the two busbars 3 are positioned along two opposite edges in the final glazing unit.

The two sheets 2 are positioned with the transparent layers that form electrodes opposite one another, an interlayer film being placed between the two transparent electrodes. This film is a film of liquid crystal droplets having a size of approximately 1 to 5 μm trapped by a transparent polymer matrix (made of PDLC in particular) in accordance with an encapsulation technique. These liquid crystals make it possible to modify the opacity of the glazing as a function of the voltage applied to the glazing.

Represented in FIG. 1 is a partial top view of the lower glass sheet, on which a device 4 according to the invention has been placed, for connection of the busbar 3 to an external current source.

The device 4 is constituted of two parts internal and external to the glazing unit 1, respectively 4A and 4B, that will now be described with reference to FIGS. 3 to 5.

The part 4A consists of a box for connection to the external current source. This box 4A has the shape of a rectangular parallelepiped, being delimited by two longitudinal faces (4a; 4b), by two transverse faces (4c; 4d) and by two end faces (4e; 4f).

One of the end faces (4f) has a central hole, to which is connected, along the central line of the box 4A, a cylindrical element 5, the outer wall of which forms, in the vicinity of its free end, an annular projection 6. A connector with a male lug having an end fitting 7 for leaktight coupling with a socket having a female lug is thus formed.

The face 4a of the box 4A is intended to be applied against the edge of the laminated glazing unit as can be seen in FIG. 1. It bears, externally, pins 8, the role of which is indicated below.

The faces 4b, 4c and 4d externally comprise hollow parts 9 formed in transverse planes parallel to the walls 4e, 4f in order to form an alternation of hollows and of ribs that favor the gripping of the part.

The face 4a comprises a central opening in the form of an elongated rectangle connected to which is an element of the case 10 type, the two main faces of which 10a, 10b opposite one another are positioned in the longitudinal direction of the box 4A. The face 10a comprises a central opening 11. Introduced into the case 10 is a conductive tab 12 intended to provide a connection with the busbar 3. This tab 12 constitutes here, with the case 10, the part 4B of the connection device, internal to the glazing unit 1.

The installation of the connection device 4 is carried out as follows:

On the first sheet of glass 2 provided with its electrode layer with its busbar 3, the connection device 4 is placed with the face 4a of the box 4A against the edge of said glass sheet 2 and the tab 12 on the electrode layer, the end of said tab 12 overlapping the busbar 3, and the case 10 pressing against said electrode layer in the edge region. In this position, the opening 11 of the case is on the opposite side from the electrode layer.

The free end of the tab 12 with the busbar 3 is welded at 13.

The interlayer film is then positioned by making it jut out into the support zone of the box 4A against the edge of the glazing unit.

Next, placed on the interlayer sheet is the second sheet having a glass function (upper sheet) that has been provided with a same connection device 4 according to the invention, the box 4A of which is located on the same side of the laminated glazing unit but in the opposite corner. The interlayer sheet then undergoes flow, entering, on the one hand, into the openings 11 of the cases 10 and, on the other hand, into the spaces between the pins 8 of the two boxes 4A.

The presence of the openings 11 and of the pins 8 thus ensures that the mechanical forces to which the boxes 4A will be subjected will in fact be transferred only to the cases 10 and not further to the tabs 12 due to the anchorage which is thus produced from the case parts 10 and from the boxes 4A to the interlayer sheet.

In the embodiment from FIG. 2, use is made of a box 4A similar to that of the embodiment from FIG. 1, but that comprises a second connector, identical to the first, borne by the face 4e of the box 4A. In this example, a single device 4 is installed on one of the sheets 2, a device for which the tab 12 is connected to two busbars 3, 3′ positioned along one and the same edge of the laminated glazing unit, perpendicular to the tab 12 and on both sides of the latter. One of the busbars (3) is associated with the lower sheet 2, extending over the entire length of the latter (represented partially in FIG. 2) and the other (3′) extends by being bent in order to be applied against the other sheet 2 (upper sheet).

Still within the scope of the present invention, the connection device may be used with any active system that requires a current or signal input and/or output.

1-15. (canceled)

16. A connection device configured to equip a laminated glazing unit requiring an electrical connection to equipment outside of the glazing unit, the laminated glazing unit including at least one set of two sheets having a glass function between which are positioned a lamination interlayer sheet and at least one current lead, the connection device comprising:
conductive portions that extend both on an inside and on outside of the glazing unit, the internal conductive region configured to be connected to the at least one current lead and the external conductive region configured for connection to the equipment outside of the glazing unit and protected by an insulating shell,
wherein the external conductive region with its insulating shell is in a form of a connection box for connection via wiring to the equipment outside the glazing unit, the box including means for receiving the conductive portion inside the glazing unit.

17. The connection device as claimed in claim 16, wherein the box is configured to be applied against the glazing unit, or against an edge of the glazing unit.

18. The connection device as claimed in claim 16, wherein the conductive portion is configured to extend on the inside of the glazing unit and includes a tab or braid of conductive material, which, in an assembled position of the connection device, enters into a slot of the box to be connected to the external conductive portion that is inside the latter.

19. The connection device as claimed in claim 18, wherein the external connection box comprises, in its junction zone with the tab of conductive material, a part that forms a case as a single piece with it, in which the tab extends.

20. The connection device as claimed in claim 16, wherein the box externally comprises one or two connectors that each bear a male lug or a female lug for connection to a respectively female or male plug of a connection cable that connects to the power source.

21. The connection device as claimed in claim 20, wherein each connector includes means for fastening, or by snap fastening, that cooperate with complementary means of the plug of the connection cable, to seal the connector-plug connection.

22. The connection device as claimed in claim 19, wherein the box and/or the internal conductive portion and/or, when it is present, the part that forms a case between the box and the tab-shaped internal conductive portion, comprise anchoring means to cooperate with the glazing unit to strengthen fastening of the connection device.

23. The connection device as claimed in claim 22, wherein the anchoring means includes holes, pins, projections, or ribs for anchoring the flexible material of the interlayer sheet, the means for anchoring the box configured to cooperate with an overlap of the interlayer sheet in a region of application of the box against the glazing unit, or against an edge of the glazing unit.

24. The connection device as claimed in claim 22, wherein the case includes lateral extensions that favor anchoring in the material of the interlayer sheet.

25. A process for assembling a laminated glazing unit including at least one connection device as defined in claim 16, comprising:
placing the connection device on a sheet of the glazing unit comprising at least one current lead;
welding the internal conductive portion of the connection device to one end of the at least one current lead, the box butting against the glazing unit,
the stack of sheets making up the laminated glazing unit being supplemented, the intermediate interlayer sheet being, where appropriate, chosen to have a dimension that enables it to jut out from the glazing unit in the region of the box so that flow of material of the interlayer sheet in this region during assembling of the stack of sheets strengthens anchoring of the box, such an anchoring possibly being favored by holes, pins, projections, or ribs borne by the latter.

26. A laminated glazing unit requiring an electrical connection to equipment outside of the glazing unit, the laminated glazing unit comprising at least one set of two sheets having a glass function between which are positioned a lamination interlayer sheet and at least one current lead,
the glazing unit comprising at least one connection device as defined in claim 16.

27. The glazing unit as claimed in claim 26, comprising a lamination interlayer sheet directly in contact with the adjacent sheets having a glass function, the at least one current lead being positioned on the interlayer sheet.

28. The glazing unit as claimed in claim 27, wherein the glazing unit is a heated glazing unit, the interlayer sheet comprising heating resistance wires connected to one or some of the at least one current lead.

29. The glazing unit as claimed in claim 26, comprising a lamination interlayer sheet in contact with the adjacent sheets having a glass function with interposition of a thin layer that forms an electrode deposited on the sheet having a glass function, the at least one current lead being positioned on the thin layer forming an electrode.

30. The glazing unit as claimed in claim 26, comprising a glazing unit having electrically controlled optical properties, thin layers that form electrodes serving as an electrical power source for an active system constituted by liquid crystals that are within the matrix of the lamination interlayer sheet and that make it possible to modify opacity of the glazing unit as a function of a voltage applied to the electrodes.
